(19) United States
(12) Patent Application Publication
(10) Pub. No.: US 2012/0323596 A1
(43) Pub. Date: Dec. 20, 2012

(54) Systems and Methods for Managing Payments and Related Payment Information for Healthcare Providers

(75) Inventors: Jay R. VerHulst, Belleair Beach, FL (US); Robert M. Hemmer, Glen Rock, NJ (US); Todd Roberti, Montville, NJ (US)

(73) Assignee: Premier Healthcare Exchange, Inc., Bedminster, NJ (US)

(21) Appl. No.: 13/495,056

(22) Filed: Jun. 13, 2012

Related U.S. Application Data
(60) Provisional application No. 61/498,021, filed on Jun. 17, 2011.
(60) Provisional application No. 61/604,722, filed on Feb. 29, 2012.

(51) Int. Cl. G06Q 50/22

(52) U.S. Cl. 705/2

(57) ABSTRACT

Systems and methods for managing payments and related payment information for healthcare providers, where payments are made by payors other than a patient, are disclosed. In some embodiments the system provides different services to member and non-member providers.

### RELATED APPLICATIONS

This application claims the benefit of U.S. Ser. No. 61/498,021 filed Jun. 17, 2011 titled “System and Method for Payment Facilitation,” and U.S. Ser. No. 61/604,722 filed Feb. 29, 2012 titled “System and Methods for Managing Payments for Medical Services and Providing Payment Information,” the entire contents of both which are hereby incorporated by reference.

### FIELD

Embodiments disclosed herein relate to systems and methods for facilitating payment to healthcare service providers for their services by non-patient payors.

### BACKGROUND

Medical service providers are often paid for their services by payors other than a patient. For example, insurance companies, self-funded corporations, unions, and other third-party payors may adjudicate claims in accordance with a plan of benefits for their plan members (the insured patient). Doctors, dentists, and other medical service providers receive checks and other payments and may identify payments in an office practice management system. Such providers may also receive an explanation of benefits or explanation of payment which may provide information allowing them to apply the payment to an insured patient's account. Payment from patients is typically accepted in the form of cash, check, or credit/debit card. Providers may accept payment from patients by credit card or debit card (such as VISA™, Mastercard™ and AmericanExpress™) using credit card machines or terminals which are used to transfer funds from a bank associated with the patient's card or acquirer bank to a merchant account associated with the particular machine/terminal.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim. One embodiment discloses a method of receiving, at a processor, at least one payment request from at least one payor, the at least one payment request requesting a plurality of payments; the processor determining that one or more of the plurality of payments are payable to a service provider for medical services rendered by the service provider; the processor determining a single payment, the single payment being an aggregation of funds from the one or more payors to pay the plurality of payments requested by the at least one payment request; and the processor providing an instruction to make the single payment to the service provider.

### BRIEF DESCRIPTION OF THE FIGURES

FIG. 1 is a payment facilitation system according to an embodiment.

FIG. 2 is a payment facilitation system according to another embodiment.

FIG. 3 is an illustration of a process of obtaining and converting a data file for printing checks/EOBs/EOPs into an electronic payment file according to an embodiment.

FIG. 4 is an illustration of a process of enrolling in a payment facilitation system according to an embodiment.

FIG. 5 is an illustration of a process of membership recruitment according to an embodiment.

FIG. 6 is an illustration of a process of reconciling payments according to an embodiment.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

A medical service provider may provide services to multiple patients and accept payments from multiple payors including but not limited to the patients themselves, insurance companies, self-funded corporations, unions, and other third-party payors. An intermediary can act between payors and service providers to reduce the amount of effort required by the medical service provider to accept and track payments made by payors for services provided to patients.

An exemplary payment facilitation system may use an intermediary server which acts as an intermediary between one or more payors and one or more service providers to provide various functions related to the payment of a provider for services. Such functions include, but are not limited to, aggregating payments, providing a physical or virtual card preloaded with funds for payment, pushing the payments to a provider's credit card merchant account, transferring the payment to a provider's bank account and/or tracking information related to the payments. A merchant account may be a line of credit account or a bank account with an acquiring bank or financial institution that processes credit and/or debit card payments. The intermediary server may be provided by a third party other than the payors and service providers. The payors and service providers, for example, may contract with the third party intermediary to perform such functions. In one embodiment, the system offers different tiers of membership where the different tiers receive different services. As a specific example, the intermediary may process payments on behalf of a payor to both service providers that are members and service providers that are not members, providing features to members that are not available to the non-members.

An exemplary payment facilitation system may include a third party system that receives a plurality of payment files, payable to one or more member and non-member providers of the third party system, from a plurality of payors. The system may determine that one or more of the payment requests are payable to a member provider. The system may then request and aggregate funds from multiple payors into a single payment to a member provider. The single payment is made to an account associated with the member. If the member provider has chosen to have his aggregated payment pushed into his merchant account, the payment may be pushed into his merchant account without requiring that the member act to receive the payment. To accomplish this the member provider may have provided the third party system with information sufficient to identify his merchant account. Thus, the member provider would receive the aggregated payment in his merchant account as a push payment, i.e., without necessarily having to enter any information into his credit card machine, terminal or web based computer program.

In another embodiment the member provider may have chosen to have the single aggregated payment transferred from the account associated with the member provider directly to his bank account using the Automated Clearing House (ACH), which is an e-payment network which allows fund transfers to occur using Electronic Funds Transfer (EFT).

The following example is provided to illustrate an exemplary use of a system in which an intermediary acts to aggregate and/or push payments directly into a member provider's merchant account or bank account. In this example, two payors (P1 and P2) each send requests to the intermediary server requesting payments be made and delivered to each of two medical service providers Ml and M2. An exemplary request is an electronic message or file containing the details of the request. Medical service provider Ml is a member of the third party system and has set up his account to have his/her aggregated payments pushed to his merchant account, in doing so Ml has provided the third party system with sufficient information to identify his merchant account with a merchant bank, for example the member provider's Merchant ID and Terminal ID. Service provider M2 is also a member of the third party system and has set up his account to have his his/her aggregated payments deposited directly into his bank account, and has provided the system with sufficient information to identify his bank account. The intermediary server receives P1 and P2's payment requests and determines that payments are to be made to both M1 and M2.

The intermediary server requests the funds for M1 from P1 and P2's accounts and coordinates the transfer of those funds into a bank account associated with Ml. This account is used by the system for issuing payments to M1. The intermediary server then instructs the bank server to push the funds, which amount to the aggregated payment from P1 and P2, from the bank account associated with Ml to a processor for receipt, processing and depositing into M1's merchant bank account. In doing so, the funds appear in M1's merchant account as if M1 accepted a credit card payment via the member provider's credit card machine or terminal for the single aggregated payment amount, but without any action being taken by M1, i.e., M1 does not have to swipe a credit card through a credit card machine. The push can be facilitated by a transaction processor that, for example, also receives requests to make payments into the merchant account via an associated credit card machine or terminal. The processor may be a part of a credit card network, it may be associated with the intermediary server, it may be associated with a merchant bank server, or may otherwise be provided.

Service provider M2, having requested his aggregated payment be deposited directing into his bank account, will have provided the third party system with information related to his bank account, such as the routing and account numbers for the member provider's account. The intermediary server requests the funds for M2 from P1 and P2's accounts and transfers those funds into a bank account associated with M2 and used by the system for issuing payments to M2. The intermediary server then instructs the bank server to push the funds, which amount to the aggregated payment from P1 and P2, from the bank account associated with M2 directly into M2's bank account, in some cases using ACH. Both M1 and M2 may receive notification of the aggregate payment made and may have access to information related to their respective aggregate payments via a secure web portal.

Pushing payments into a member provider's merchant account may be accomplished in various ways. In an exemplary payment facilitation system where a member provider chooses to have his/her single aggregated payments pushed to his merchant account, he may provide information sufficient to identify his merchant account including, for example, one or more of a Merchant ID, Terminal ID, Connection User Name, Connection Password, BIN (Bank Identification Number), Terminal ID, Bank ID, User Name, Password, Check Digit, POSID (Point of Sale ID), Authentication Code, Merchant Zip Code, or other information sufficient to identify the member provider's merchant account.

In still yet another embodiment the member may be issued a virtual or physical card, which may be a reloadable or a one time use card. The card may be associated with an account at a card issuer bank associated with the member provider. The member provider may choose to have his/her single aggregated payments transferred to the account at the card issuer bank associated with the member provider's card. When swiped in a payment card device, either physically or by manually entering the card numbers into the device, the card may move funds from the card issuer bank account associated with the member (and card) to the account to which the credit card device is linked. When the card is swiped the number is entered into the credit card terminal and the payment amount is entered, the terminal requests funds from the card issuer bank server using a processor such as the United States credit card association network. A response, such as an approval, may be transmitted to the credit card terminal. Upon approval, funds may be electronically moved from the account associated with the member at the card issuer bank to the account associated with the credit card terminal as dictated by the bank associated with the card's settlement process. For example, funds payable to a member provider from various payors may be deposited into an account associated with the member provider (and card) at the card issuing bank, and when the card is swiped in the credit card terminal, the funds may be moved from the account at the card issuer bank to the merchant account linked to the credit card terminal. The member provider may receive a notification, such as an e-mail, text message or fax, notifying the member provider that funds are available on the member's card and the amount of the aggregated payment available.

A reloadable card may be similar to a stored value card in that an amount is deposited for either type of card. A reloadable card may differ from a stored value card in that a stored value card may be a one-time use card, for example a gift card. A reloadable card may be used multiple times for multiple transactions. A reloadable card may have an expiration date, but like credit cards the card may expire years after the issue date, and may be replaced with a current card prior to that expiration date. A stored value card may have an expiration date for the amount loaded on the card, may not be reissued, and may not be loaded with additional funds beyond the initial value. A virtual card may comprise a file or notification containing information sufficient to allow the provider to transfer funds from the account associated with the member provider to the member provider's merchant account, using the member provider's credit card terminal. For example, a virtual card may be an e-mail or facsimile containing a card number, an expiration date and a card security code, each of which may be manually entered into the member provider's credit card terminal to transfer funds from the account associated with the member provider and the card to the member provider's merchant account.

In an embodiment, once a provider becomes a member, information about the provider may be compiled and added to a membership list. A card associated with a card issuing bank may be mailed or delivered to the member provider office staff. This delivery may also include introductory materials. This card delivery may be initiated by the system. The member provider card may be physically sent out by the card issuing bank. The system may direct the card issuing bank regarding what cards and/or materials to send and when, where, and how to send them. In some embodiments, the acts of sending out the card and associated materials may be performed by the card issuing bank. In other embodiments, the card issuing bank may outsource the process to a certified fulfillment company. In some other embodiments, no card may be issued, in which case the aggregated payment may be made directly between banks through ACH transfers, may be pushed directly into a member provider's merchant account, or otherwise.

In some embodiments, member providers may have a merchant category code (MCC) assigned to their reloadable card which may limit the card's use to certain payment card terminals. For example, the MCC code may be a four-digit number assigned to a business by MasterCard, VISA, or some other card provider. In some card networks and systems, all merchants have an MCC associated with their payment card terminal when the business starts accepting a reloadable card as a form of payment. In the case of a member provider, the MCC may signify that the MCC assignee is a medical provider. The card may be limited to use with a card terminal having a matching MCC assignment and/or to card terminals having codes indicating that they are associated with medical providers.

Non-member providers may not be offered the same options for payment for their services. For example, non-member providers may only receive non-aggregated payments on a payor-by-payor basis via either printed check, or one-time use cards. The one-time use card may be either a physical card or a virtual card and may be pre-loaded with the payment amount associated with a single payor's payment. A non-member may not have access to the portal and may not receive a notification that a payment has been loaded onto the one-time use card, other than receipt of the card and instructions for its use.

In an embodiment the intermediary server may also provide a member provider with a notification of a payment made via ACH, deposited into the merchant account, or made available via the virtual or physical card. The intermediary server may also provide access to information related to the aggregated payment, for example the payments aggregated on a payor-by-payor basis, and an explanation of payment (EOP) for each payment included in the aggregate payment. This information may be accessible via a web portal or other network access.

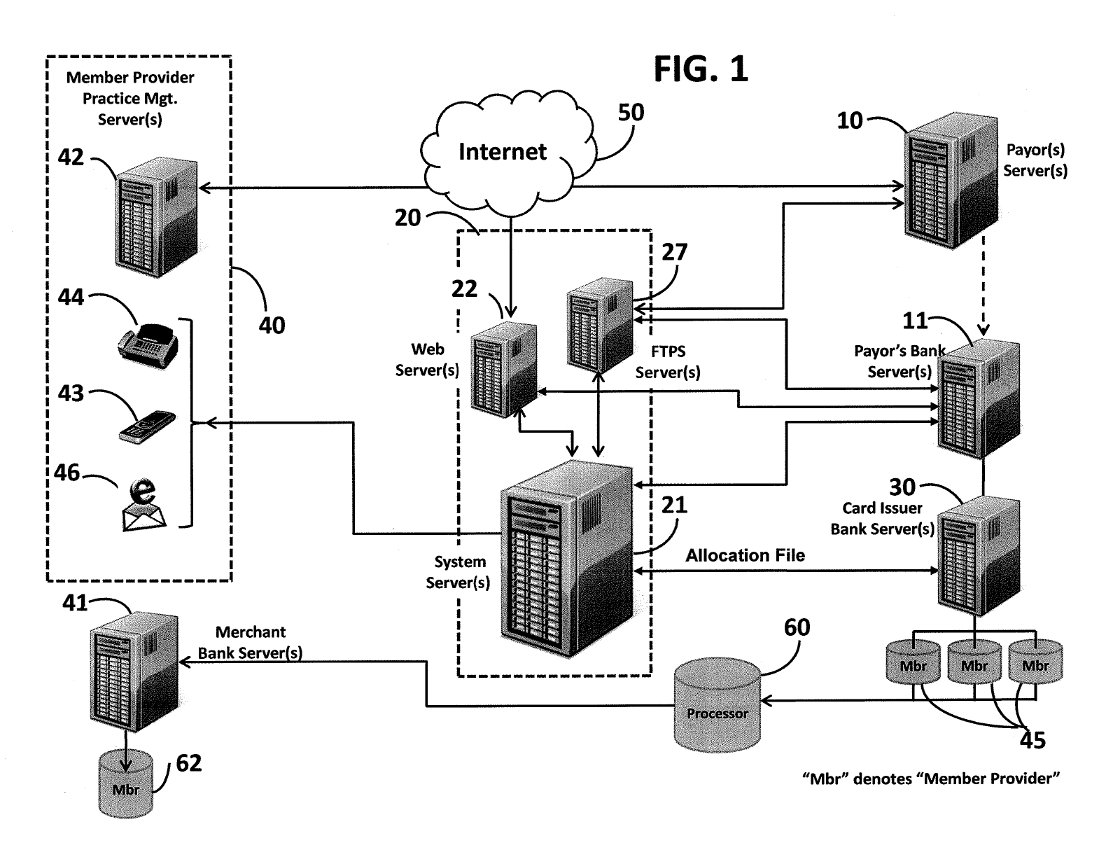

The web portal may provide several functions to users. For example, providers may elect to become members, options may be made available to members such as communication options for notification of available funds (for example, by text message to a phone. e-mail, or fax), options on how to receive data detailing payment information (such as EOP data) into member record keeping systems or practice management systems (such as system 40 shown in FIG. 1) (for example by printing and manual entry, downloading various file types for importing into the practice management system, and/or visually reviewing the EOP data).

Users associated with the member providers may log into the web portal and may view transactions, print them, and/or download them in a file which may be imported into the member provider's practice management system. For example, this file may be used to note received payments in patient accounts. Historical and recent transaction records may be maintained and made accessible in the web portal. The data downloaded by the member provider may be transmitted using any technology, for example SMTP, SMS, MMS, HTTP, HTTPS, FTP, and/or other formats. In some embodiments the member provider users may download a spreadsheet file, a CSV file, a PDF file, or an 835 file for loading into their practice management system. An 835 is an insurance industry standard X12 Transaction Set. The data contents of the health care claim payment/advice 835 file may be used to make a payment and/or send an EOP remittance advice from a payor to a health care provider either directly or via a financial institution. The web portal may also allow a user to select member features, to select how they are notified of funds availability, and/or select how they obtain data to load into their practice management system and reconcile payments. For example, a day's payment may be an aggregated amount of $12,000 for ten different patients from ten different payor servers. By loading the file into their practice management system, a user may be able to electronically cancel out receivables for the ten patients from the ten different payor servers. The web portal may provide information about membership benefits and policies. The web portal may also enable membership activation by collecting registration data from providers. Should a provider decide to become a provider member, they may have the ability to create a user ID and password within the membership portal, elect notification means for payment notifications (for example, e-mail, dial-up IVR, fax, text message to a mobile device, member log-in), agree to terms of membership, give notice of payors from which they would like to receive payment through the system, and/or provide a digital signature agreeing to terms of membership

FIG. 1 depicts an exemplary payment facilitation system. In some embodiments, the system 20 may facilitate payments for medical services to medical service providers from entities responsible for paying at least a portion of those services (“payors”). The system 20 may comprise one or more computers. A computer may be any programmable machine capable of performing arithmetic and/or logical operations. In some embodiments, computers may comprise processors, memories, data storage devices, and/or other commonly known or novel components. These components may be connected physically or through a network or wireless links. Computers may also comprise software comprising instructions performed by one or more processors that may direct the operations of the aforementioned components. Computers may include servers, PCs, mobile devices, and other devices that are capable of performing the described functions.

The computers of the system 20 may include one or more servers 21, webservers 22, and/or FTP servers 27. In some embodiments, various functions associated herein with the system servers 21, web servers 22, and FTP servers 27 may be added, omitted, or modified. In some cases different servers may perform different functions, or functions may be shared among servers in different ways without departing from the scope of the specification. A system server 21 may process data sent to or received from a payor server 10, payor's bank server 11, card issuer bank server 30, member provider server 42, and/or any other server. The system server 21 may communicate with these servers via a web server 22, FTP server 27, and/or any other communication channels or networks which may connect the various servers using traditional or novel communication lines and protocols. The member provider server 42 may be a server, Person Computer (PC), mobile device, or other device capable of performing the described functions.

The web server 22 may provide a communications portal which houses the system's web site, and may handle communication with the Internet 50 in some embodiments. The system's web site or web portal, may provide public and/or private visibility to membership services and information which may be associated with the system. Providers may sign up to be members of the system and in doing so may have increased options and benefits for services provided by the system as compared with non-members. For example, non-members may not receive single aggregated payments, but instead may be limited to receiving a payment on a payor-by-payor basis via a physical or virtual card that must be swiped or manually entered in their credit card terminal. Member providers, however, may receive single aggregated payments from multiple payors that may be pushed directly into their merchant accounts without having to swipe a credit card, or transferred to their bank account via an ACH transfer.

One or more payor servers 10 may be connected to the system 20. A payor server 10 may be a server operated by a payor, such as an insurance company, self-funded corporation, third-party administrator, union, or the like. Connections to the payor server 10 may include a variation of file transfer protocol such as FTP or FTPS, Internet 50 file transfer, a direct data line connection using commercially available or propriety data lines and transmission protocols, and/or secure and non-secure email communication via the Internet 50. The FTP server 27 may provide FTP and/or FTPS (secure FTP) connectivity between computers in the system 20 and external servers such as the payor server 10, the payor's bank server 11, and/or others. In some embodiments the connection type may be selected by the payor server 10.

One or more of payor's bank servers 11 may be connected to the system 20. A payor's bank server 11 may be a server operated by a bank at which one or more payors has an account. Connections to the payor's bank server 11 may include FTPS, Internet 50 file transfer, a direct data line connection using commercially available or proprietary data lines and transmission protocols, and/or secure and non-secure email via the Internet 50. In some embodiments the connection type may be chosen by either the payor server 10 or the payor's bank server 11. In some embodiments the system 20 may communicate with the payor's bank server 11 through the payor server 10. This communication option may be provided instead of, or in addition to, a connection between the system 20 and the payor's bank server 11. In such an example, the system 20 may communicate with the payor's bank server 11 through the payor server 10 by sending a communication to the payor server 10, which may reroute the communication using any of the above communication options.

One or more card issuer bank servers 30 may be connected to the system 20. In another example the card issuer bank may outsource the server's functions to a third party processor. A card issuer bank server 30 may be a server operated by a bank which may issue real or virtual cards linked to an account at the card issuer bank. The system server 21 may instruct the payor's bank server 11 to transfer funds from the payor's accounts to the card issuing bank server 30. The system server 21 may then instruct the card issuing bank server 30 to divert the funds received from the payor's bank server 11 into specific accounts associated with specific member providers 45. The card issuer bank server 30 may have accounts 45, each associated with individual member providers. The system server 21 may instruct the card issuer bank server 30 to push funds from the member provider's account 45 to a processor 60 for authorization and deposit into the member provider's merchant account 62. The processor 60 may be a credit card processor, a merchant account provider, a credit card network, the system server 21, a payment gateway or another third party processor. The processor 60 authorizes the transfer of funds and instructions the merchant bank server 41 to deposit the funds into the member provider's merchant account 62. In summary, the funds are transferred from the account 45 associated with the member provider into the member provider's merchant account 62 as if the payment had been made at the member provider's office using the member provider's credit card machine/terminal. The system may be notified by the processor 60 that the funds were successfully deposited in the member provider's merchant account 62, the system may send a notification to the member provider in a method the member provider has chosen (for example, email 46, fax 44, text 43, or displayed when a user associated with a member provider logs into the member web portal provided on web server 22). The member provider 40 may access the member web portal using member provider practice management server 42 via the Internet 50.

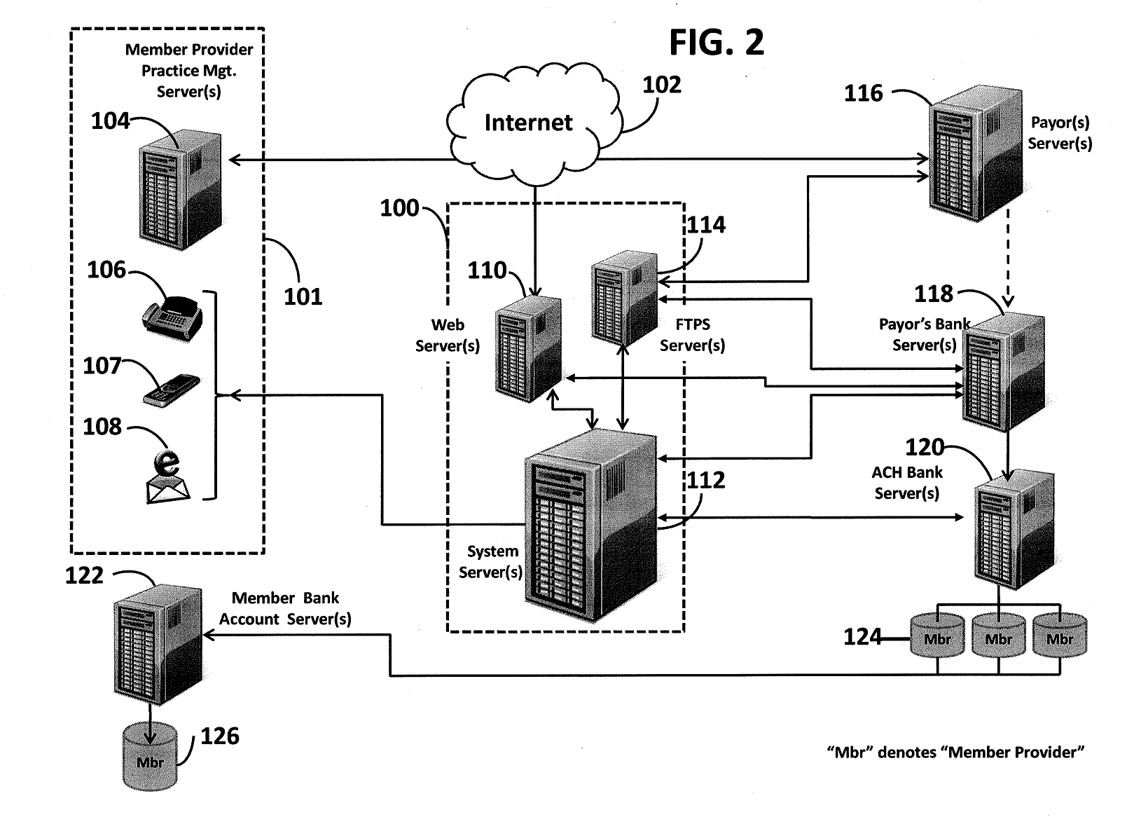

In other embodiments a bank server accessible to the Automated Clearing House Network (ACH) and member bank account server may communicate directly using ACH funds transfer systems, as depicted, for example in FIG. 2. As shown in FIG. 2 a system 100, having a system server 112 may process data sent to or received from a payor server 116, payor's bank server 118, ACH bank server 120, member bank account server 122, and/or any other server. The system server 112 may communicate with these servers via a web server 110, FTP server 114, and/or any other communication channels or networks which may connect the various servers using traditional or novel communication lines and protocols.

The web server 110 may provide a communications portal which houses the system's web site, and may handle communication with the Internet 102 in some embodiments. The system's web site or web portal, may provide public and/or private visibility to membership services and information which may be associated with the system. Providers may sign up to be members of the system and in doing so may have increased options and benefits for services provided by the system as compared with non-members. For example, non-members may not receive aggregated payments, but instead may be limited to receiving a payment on a payor-by-payor basis via a physical or virtual card that must be swiped in their credit card terminal. Member providers, however, may receive an aggregated payment from multiple payors that may be pushed directly into their bank account via the ACH.

One or more payor servers 116 may be connected to the system 100. A payor server 116 may be a server operated by a payor, such as an insurance company, self-funded corporation, third-party administrator, union, or the like. Connections to the payor server may include a variation of file transfer protocol such as FTP or FTPS, Internet file transfer, a direct data line connection using commercially available or propriety data lines and transmission protocols, and/or secure and non-secure email communication via the Internet 102. The FTP server 114 may provide FTP and/or FTPS (secure FTP) connectivity between computers in the system 100 and external servers such as the payor server 116, the payor's bank server 118, the ACH bank server 120, and/or others. In some embodiments the connection type may be selected by the payor server 116.

In some embodiments the system 100 may communicate with the payor's bank server 118 through the payor server 116. This communication option may be provided instead of, or in addition to, a connection between the system 100 and the payor's bank server 118. In such an example, the system 100 may communicate with the payor's bank server 118 through the payor server 116 by sending a communication to the payor server 116, which may reroute the communication using any of the above communication options.

One or more ACH bank server(s) 120 may be connected to the system 100, in another example the ACH bank server 120 may outsource the server's functions to a third party processor. An ACH bank server 120 may be a server operated by a bank. The system server 112 may instruct the payor's bank server 118 to transfer funds from the payor's accounts to the ACH bank server 120. The system server 112 may then instruct the ACH bank server 120 to divert the funds received from the payor's bank server 118 into specific accounts 124 associated with individual member providers. The system server 112 may instruct the ACH bank server 120 to transfer funds from the member provider's account 124 to the member provider's member bank account server 122, with instructions to divert funds in the member provider's bank account 126. In summary, the funds are transferred from the account associated with the member provider 124 into the member provider's bank account 126. The system 100 may be notified by the ACH bank server 120 or the member bank account server 122 that the funds were successfully deposited in the member provider's account 126. The system 100 may then send notification to the member provider by a method the member provider has chosen (for example, email 108, fax 106, text 107, or displayed when a user associated with a member provider logs into the member web portal)

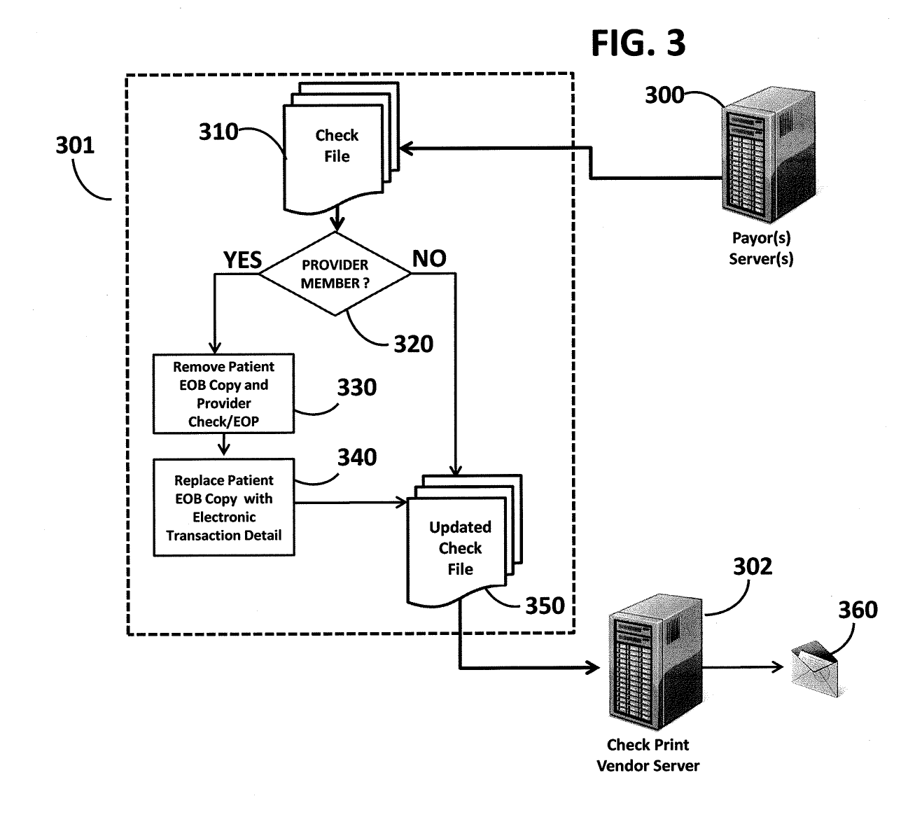

FIG. 3 depicts an exemplary process of obtaining and converting a data file intended for a printer to produce checks/EOBs and EOPS into an electronic payment file. The system 301 may provide a fully electronic payment settlement service to its provider members using various embodiments of the present invention, including, for example without limitation, a push payment to the provider's merchant account, direct transfers to the provider's bank account using the Automated Clearing House (ACH) network, though other suitable means for payment may also be used. Payor servers 300 may send check files directly to the system rather than to a check rendering vendor. The check file 310 format and any payor administrator's processes may be in any format from the payor server 300. The system 301 may import the check file 310 and compare providers' Tax Id Number (TIN), or other identifying information, in the check file 310 to a the member provider file 320, which may include information on current member providers such as TIN, to determine which claims are for payment to member providers versus non-member providers. If the payment is for a member provider, the check file 310 may be converted to an electronic payment file. If the member provider TIN is found in the check file 310, a payment to the member provider may be removed from the check file 310. The patient's EOB copy may be removed and/or adjusted to reflect electronic payment rather than check payment and then replaced 340 with an EOB containing electronic transaction details. The remaining check file 350 containing non member payments and corrected patient EOB copies may be forward on to a check rendering vendor server 302 for normal printing and mailing 360. In some embodiments the updated check file 350 may be sent to the payor, and the payor may send the updated check file 350 to the check print vendor 302.

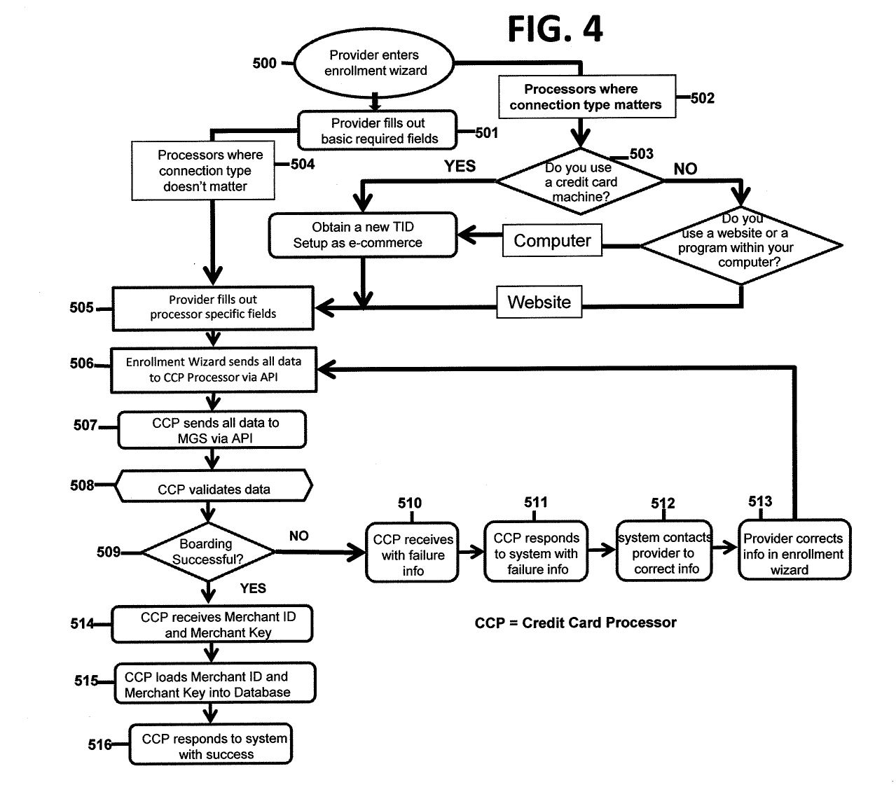

FIG. 4 depicts a process of enrollment wherein the member provider chooses to have his/her aggregated payments from payors pushed into the member provider's merchant account. The provider begins the enrollment process with the system by entering the enrollment wizard 500. If the connection type of the credit card processor used by the member provider matters 502 then the member provider selects whether the member provider uses a credit card machine 503. If the member does not accept credit cards at all, then he is routed to the ACH payment enrollment system. If the member provider uses a credit card machine then he is instructed to obtain a new Tax ID setup as e-commerce. If the member provider does not use a credit card machine then he is directed how to complete setup based on whether he uses a website or a computer program to accept credit card payments. If the member provider uses a program within the computer then he is instructed to obtain a new Tax ID setup for e-commerce. If the member provider uses a website, then he continues on in enrollment process to step 505 where he fills out processor specific fields. For member provider's whose credit card processors connection type doesn't matter, the member provider fills out basic required fields 501. Where a member provider's processor connection type does not matters 504, the member provider fills out processor specific fields 505. The enrollment wizard then send all the data it has collected from the member to the credit card processor, which may be located on the merchant bank's server, via API (application programming interface) 506. The credit card processor sends the data to a second tier processor via API at step 507. The credit card processor validates the data provided at step 508 and if the boarding is successful at step 509 then the credit card processor receives the Merchant ID and Merchant Key 514, loads the Merchant ID and Merchant Key into the Database 515 and the credit card processor responds to the system's server with success 516. If the Boarding was not successful at step 509, then the credit card processor receives notice of failure 510, the credit card processor responds to the system's server with failure info 511, the system's server contacts the member provider to correct the information provided during enrollment 512 and the member provider corrects the information entered in the enrollment wizard 513 and the enrollment wizard again sends the data to the credit card processor via API at 506 and the process continues as described above.

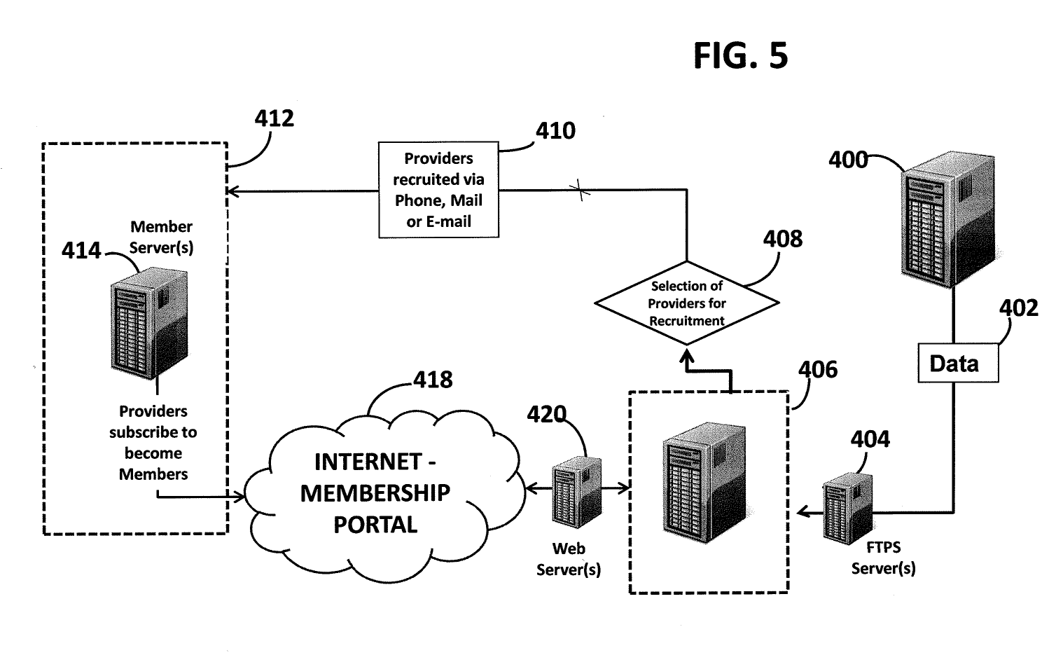

FIG. 5 depicts a membership recruitment process according to an embodiment of the invention. This process may enable the system 406 to recruit providers 412 who may then receive payments through the system 406 and/or have access to data and services provided by the system 406. Profiles of prospective member providers may be created by the system 406. Various payor servers 400 may provide data 402 detailing historical provider payments which may be imported into the system server 407 through the secure FTP server 404 or some other suitable channel. Other commercially available data may also be included when constructing the profile. Data 402 from some or all payor servers 400 may be aggregated. This data 402 may include summary data on frequency of historical payments, amounts of historical payments, and/or other relevant information. The data 402 may be used to select providers 412 for recruitment 408, and the data 402 may be used in recruitment materials.

Providers 412 who are current members and/or providers 412 who may have previously opted not to be member providers may be set aside by the system 406. In some embodiments, providers 412 who have opted out may be periodically selected for recruitment 408 and re-approached. The system 406 may select 408 providers 412 who have a relatively high frequency of payments over a dollar threshold. The frequency and/or dollar threshold may vary by marketing campaign. In some embodiments, other selection criteria may be used.

Once the providers 412 are selected for marketing 408, they may be contacted via a combination of various methods 410, for example by e-mail, mail via USPS or other carrier, telephone, and/or fax. Information presented in the recruitment process may include an Internet URL for the web portal 418. The web server 420 may also be used to recruit providers 412 using various web marketing techniques such as web blogs, random e-mail campaigns, search engine advertising, and/or the like. These web marketing techniques may direct the providers 412 to the web portal 418. A provider 412 may access the internet membership portal 418 to enroll in the system and become a member provider using the provider's server 414.

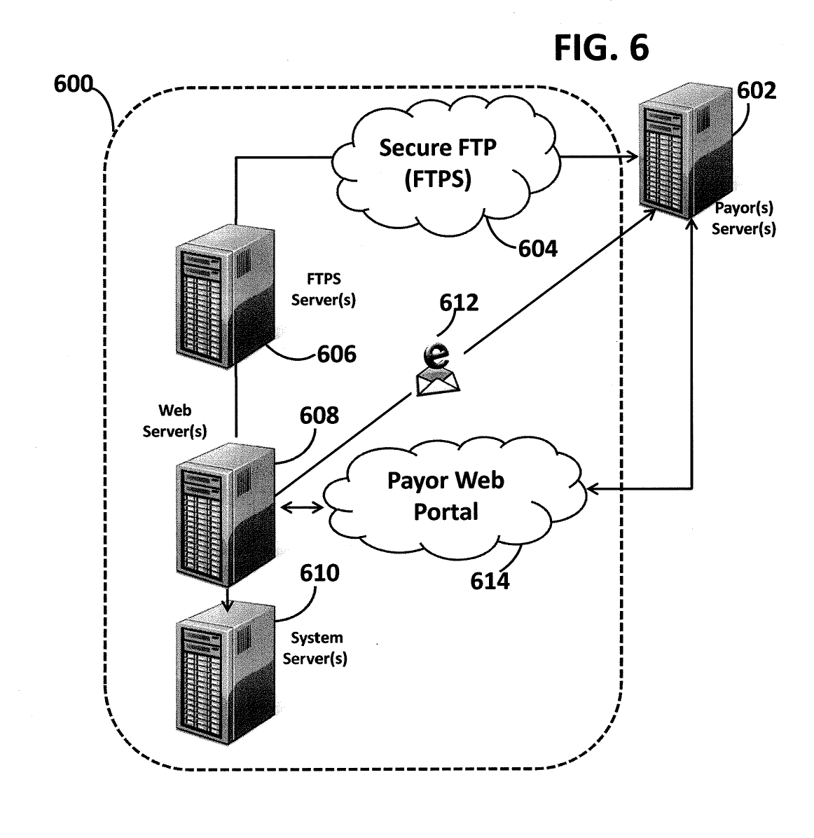

FIG. 6 depicts an exemplary process of reconciling payments to member providers. When a period's transactions have been aggregated, a payor server 602 reconciliation file may be created by the system 600. The period may be determined by the system 600, the payor, or the member provider. The reconciliation file may include the various electronic payments which are associated with checks replaced in a payor check print file. This reconciliation file may indicate which checks were replaced by an electronic payment with a reference to the electronic payment record. For example, if check number 8000 became an electronic payment, the file may contain the check number 8000 and the data receipt for the electronic payment and the corresponding amount paid. This reconciliation process may be provided in addition to an electronic file received by the payor bank displaying cleared checks. Based on the payor server 602 set up, the file may be made available to the payor server 602 through a secure FTP site 604 which may be maintained by the FTP server 606 and/or on the web portal 614 by webserver 608. The web portal 614 may be the same portal described above with respect to FIGS. 1-4, or it may be a separate portal. In some embodiments a secure email 612 may be sent to the payor server 602 indicating a file is available. In other embodiments the system server 310 may perform the actions of the web server 608 as described above.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

1. A method comprising:
receiving, at a processor, at least one payment request from at least one payor, the at least one payment request requesting processing of a plurality of payments to be paid by the at least one payor;
determining, via the processor, that the plurality of payments are payable to a service provider for medical services rendered by the service provider;
determining, via the processor, a single payment, the single payment aggregating funds of the at least one payor to pay the plurality of payments requested by the at least one payment request; and
providing, via the processor, an instruction to make the single payment to the service provider.

2. The method of claim 1 further comprising storing information related to the single payment on a server accessible via the world wide web, wherein the information further comprises an explanation of benefits for each of the plurality of payments.

3. The method of claim 1 further comprising: storing information sufficient to identify a service provider's merchant account and pushing the single payment into the service provider's merchant account.

4. The method of claim 3 further comprising: transmitting a notification message to the service provider informing the service provider that the single payment has been transferred into the service provider's merchant account.

5. The method of claim 1 further comprising: storing information sufficient to identify a service provider's bank account and transferring the single payment to the service provider's bank account.

6. The method of claim 5 further comprising: transmitting a notification message to the service provider informing the service provider that the single payment has been transferred into the service provider's bank account.

7. The method of claim 6 wherein the step of transferring the single payment to the service provider's bank account comprising using the Automated Clearing House payment rails.

8. The method of claim 1 further comprising: storing information related to the single payment on a server accessible via the world wide web, wherein the step of storing the information includes storing information related to the at least one payment file and the at least one payor including an explanation of benefits for each at least one payment file.

9. A method comprising:
receiving, at a processor, at least one payment request from at least one payor, the at least one payment request requesting processing of a plurality of payments to be paid by the at least one payor;
identifying, via the processor, payments to a service provider requested by the at least one payment request;
determining, via the processor, whether the service provider is a member provider;
if the service provider is a not a member provider;
providing, via the processor, an instruction requesting a print check vendor to print one or more checks in the amount of each of the plurality of payments to be paid by the at least one payor to the non-member provider.

10. A system comprising:
a processor for executing instructions stored in computer-readable medium on one or more devices to perform operations, the operations comprising:
receiving at least one payment request from at least one payor, the at least one payment request requesting a plurality of payments;
determining that one or more of the plurality of payments are payable to a service provider for medical services rendered by the service provider;
determining a single payment, the single payment aggregating funds to pay the plurality of payments requested by the at least one payment request; and
providing an instruction to make the single payment to the service provider.

11. The system of claim 10 wherein the operations further comprises storing information related to the single payment on a server accessible via the world wide web, wherein the information further comprises an explanation of benefits for each of the plurality of payments.

12. The system of claim 10 wherein the operations further comprises transmitting a notification message to the service provider informing the service provider that the single payment has been transferred into the service provider's merchant account.

13. A computer program product comprising a computer-readable medium embodying program code, the program code comprising:
code for receiving at least one payment request from at least one payor, the at least one payment request requesting a plurality of payments;
code for determining that one or more of the plurality of payments are payable to a service provider for medical services rendered by the service provider;
code for determining a single payment, the single payment aggregating funds to pay the plurality of payments requested by the at least one payment request; and
code for providing an instruction to make the single payment to the service provider.

14. The computer program product of claim 13, the program code further comprising:
code for sending a notification to the service provider that the single payment has been made.
